(19) United States
(12) Patent Application Publication
(10) Pub. No.: US 2005/0028661 A1
(43) Pub. Date: Feb. 10, 2005

(54) Separating device and film dispenser

(76) Inventor: Klaus Horstmann, Neuenkirchen (DE)

Correspondence Address: FLYNN THIEL BOUTELL & TANIS, P.C., 2026 RAMBLING ROAD, KALAMAZOO, MI, 49008-1699, US

(21) Appl. No.: 10/619,538

(22) Filed: Jul. 15, 2003

Related U.S. Application Data
(63) Continuation of application No. PCT/EP02/00399, filed on Jan. 16, 2002.

(30) Foreign Application Priority Data
Jan. 16, 2001 (DE) 201 00 760.6

(51) Int. Cl. B26D 5/08

(52) U.S. Cl. 83/523; 83/613; 83/614

(57) ABSTRACT

A film dispenser comprises a housing provided with at least one dispensing compartment, and a separating profile section associated with a dispensing opening of the dispensing compartment. A separating device comprising at least one separating knife and a press element is supported such that it is movable along the separating profile section transversely to a slip of film which is drawn from a roll of film disposed in the dispensing compartment. A separating device can also be implemented as a separate component and used together with a dispensing compartment and a suitable separating profile section independently of the film dispenser as an attachment or as an insert component for the film dispenser. In order to improve a film dispenser or a separating device of this kind in such a way that the drawn slip of film can, for the purpose of cutting, be fixed more effectively on the basis of a simple structural design and at a reasonable price, the press element is implemented as a moving strip which is supported such that it is adapted to circulate in said separating device and which causes the slip of film adjacent to the separating knife to remain tensed at least in a linear manner along the direction of displacement of said knife.

The present invention relates to a separating device and a film dispenser, which includes such a separating device, with the features of the generic clause of claims 1 and 21.

A separating device of the type in question is known from WO 95 046 94, said separating device forming part of a film dispenser. In the case of this separating device, endless soft-rubber bands are provided as hold-down devices, said soft-rubber bands circulating around rolls which are implemented as rims. The respective rolls are arranged in pairs on either side of a suitable separating knife.

A film dispenser comprising a separating device is known e.g. from DE 93 21 258 U. In the known film dispenser, two dispensing compartments are arranged on top of one another, each of said dispensing compartments containing a roll of film/foil. Each of the dispensing compartments is provided with a separating device which is supported such that it is displaceable along the respective dispensing compartment. The separating device comprises at least one separating knife and a press element. The press element, is defined by a roll or by a pair of rolls pressing a slip of film, which is drawn from a roll of film, against a separating profile section in front of and behind the separating knife, when seen in the direction of said separating knife. The separating profile section is provided with a cutting slot, and the separating knife engages part of said cutting slot. The roll used as a press element according to DE 93 21 258 U fixes the slip of film in the area of the cutting slot essentially only pointwise. In addition, at least two press rolls have to be used for sufficiently fixing the web of film, which makes the structural design of the separating device comparatively expensive as far as the arrangement and support of the press rolls is concerned.

It is therefore the object of the present invention to improve a separating device and a film dispenser of the type mentioned at the beginning in such a way that material in the form of webs or sheets which has been removed from a roll is, for the purpose of cutting, fixed more effectively on the basis of a simple structural design and at a reasonable price.

This object is achieved by the features of claims 1 and 21, respectively. According to the present invention, the material is fixed not only pointwise, but in a linear manner in the direction of displacement of the separating knife. This has the effect that, during the cutting operation, the material is held along a longer portion thereof in the direction of displacement of the separating knife and can thus be cut more easily and more effectively. The use of the subject matter according to the present invention results in a neatly cut edge whose cutting line is neither frayed nor tom. The moving strip is supported in a simple manner in the separating device such that it is adapted to be moved in a circle, and separately supported press rolls having a special structural design are not necessary.

As far as the separating device is concerned, reference should also be made to the fact that said separating device is adapted to be used as an integrated component of a film dispenser, as an attachment or an insert component for such a film dispenser, or as a separate component independently of a film dispenser. The separating device can be used for cutting various materials in the form of webs or sheets, such as film/foil, paper, fabric, photographic paper and the like. When the respective separating device is used in a film dig penser, the material in question can especially have the form of a slip of film/foil and can comprise paper, aluminium or a plastic material which is suitable for packing in particular food.

In this connection, it should additionally be taken into account that, depending on the width of the moving strips, the slip of film can also be pressed against the area adjacent to the separating knife in a planar manner.

In order to fix both the web of film and the slip of film that has already been cut off, at least one moving strip can be arranged on either side of the separating knife. In order to facilitate a circulatory movement of the moving strip, the moving strip can be rotatably supported. The elements used for supporting the moving strip in this way can be rolls or the like.

The moving strip can be guided essentially parallel to the separating profile section in the direction of displacement of the separating knife so that said moving strip can be used for fixing the web of film and the slip of film over the whole length of the moving-strip portion associated with the separating profile section.

In order to guide the moving strip in a suitable manner also in front of and behind the separating device, a parallel guide means of the separating device, which is used for guiding the moving strip, can extend beyond the separating knife on both sides in the direction of displacement. This has the effect that the moving strip will produce a film-fixing effect already in front of the separating knife and maintain this fixing effect at the sides of and up to a point behind the separating knife.

In order to permit easy handling of the separating device with the separating knife, the separating device can be provided with a handle housing, in particular a bipartite handle housing, in which the separating knife is held and in which the moving strip is guided.

In order to provide a simple structural design of the separating device in the case of a further embodiment, the separating device can comprise a substantially U-shaped handle housing which is adapted to be attached, in particular lockingly attached, to an inner member. The inner member serves in this connection as a support for the separating knife. The moving strips are placed around said inner member and they are in particular movable relative thereto. The separating knife can project beyond a lower surface of said inner member between the moving strips.

In order to fasten the separating knife in the handle housing in a simple manner and in order to fix it in position, at least one handle-housing half can be provided with a fastening element for the separating knife and one handle-housing half can be provided with a stop element for the separating knife. The stop element can be formed as a step in the handle-housing half on which the separating knife abuts with an upper edge thereof, whereby tilting of the separating knife about the fastening element will be prevented.

In accordance with a simple embodiment, the fastening element and/or the stop element can be implemented as peg- or pin-shaped elements. The separating knife is provided with complementary openings through which the peg- or pin-shaped elements can be passed. The step-shaped stop element can, for example, also be replaced by a pair of stop pins which abut on the upper edge of the separating knife at spaced-apart points.

The handle-housing half can be provided with a slot-shaped guide means for the moving strip so that said moving strip can be movably supported in the handle housing in a simple manner. Rolls or other rotatable elements are therefore not necessary for supporting the moving strip.

When e.g. two moving strips are used on the two sides of the separating knife, one moving strip can be guided in each handle-housing half.

The handle-housing halves can have a substantially symmetric structural design, and the separating knife can be held between them. The handle-housing halves can be connected to one another e.g. by means of a screw or by other connecting elements. When the handle-housing halves are being connected, the separating knife is fixed in position in the handle housing in a tilt-proof manner by means of the fastening element and the stop element

The separating knife and the inner member can be formed as an integral component so that the separating knife can be arranged in a simple manner in the separating device. This has the effect that the inner member/separating knife unit can be prefabricated and connected to the substantially U-shaped handle housing by locking engagement therewith. In this connection, reference should additionally be made to the fact that, independently of the nature of the separating knife, the inner member can be implemented uniformly so that handle housings, which are implemented uniformly as well, can be attached thereto by locking engagement therewith. The handle housing can thus be replaced easily.

In order to prevent excessive frictional forces between the moving strip and the handle-housing half in an embodiment according to the present invention, the moving strip can be guided with a certain amount of play around an approximately kidney-shaped guide member in the handle-housing half. An excessively close contact between the moving strip and the guide member is prevented in this way; the friction caused between the moving strip and the guide member in the case of such an excessively close contact could impede a movement of the moving strip around the guide member.

The separating knife can be made of plastic material so that an aluminium foil can be cut effectively and reliably.

When the separating knife is made of plastic material, it may be considered advantageous to form said knife integrally with an inner member which is made of plastic material as well.

In order to be able to cut a plastic film in a corresponding manner, the separating knife can be made of metal.

When the separating knife is made of metal, it can be combined with a plastic inner member by means of an adhesive or by some other kind of connection so as to form an one-piece unit. It is also possible to apply the inner member directly to the separating knife by means of injection moulding.

The separating knife can be provided with a base element which is guided in a suitable guide means along a cutting slot of the separating profile section so that the separating device can be guided more easily along the cutting slot. The base element is arranged on the separating-knife end located opposite the handle housing and is adapted to be displaced along the guide means. The base element can be supported in different ways within the guide means so as to prevent the separating device from becoming detached from the separating profile section. Various kinds of base elements and guide means are described e.g. in Utility Model DE 93 21 258 U, which has already been mentioned hereinbefore. Corresponding guide means and base elements can also'be used in the case of the present invention.

The separating profile section can be formed in a flap, which is associated with the dispensing compartment and which is pivotable between an open position and a closed position, so that the separating device can be displaceably supported in a simple manner and without any additional structural measures being required. The flap is used for opening the dispensing compartment and for inserting a new roll of film, or for the initial removal of a slip of film which can be drawn out through a slot between the flap and the housing or between neighbouring flaps. The separating device can also be implemented as a separate component which may have integrated therein a dispensing compartment. This component can be attached to or installed in the film dispensers. The component can also be used separately, without any film dispenser.

The flap can be releasably locked with the housing in its closed position so that each flap will reliably retain the roll of film in the housing.

The lateral ends of the flap can be pivotably supported and/or locked in position in the housing so that the flap can be pivotably supported in a simple manner and so that, if desired, also the looking can be effected easily.

The lateral ends of the flap can be provided with lateral cheeks projecting in the direction of the respective dispensing compartment so that the flap can be reliably guided when it is being moved to its closed position and so that the dispensing compartment is laterally delimited when the flap occupies its open position. These lateral cheeks engage the dispensing compartment when the flap is being pivoted to the closed position and serve at least partially as guide means along the pivoting path of the flap. In addition, the lateral cheeks define lateral boundaries when the flap is at its open position, said lateral boundaries making it easier to insert a roll of film and preventing unintentional falling out of a roll of film.

Support axles can project from the lateral ends of the flap so that the flap can be pivoted into the housing as far as possible. The flap is adapted to be pivoted between the open position and the closed position about these support axles. The support axles can be arranged such that, when occupying its closed position, the flap is arranged such that its surface is essentially flush with the front side of the housing.

In order to be able to effect, at the closed position, locking also in the area of the lateral ends of the flap, suitable locking elements may also be provided on these lateral ends. In the case of one embodiment, each lateral cheek may have an elastically deflectable arm on which a locking element is arranged, said locking element being in engagement with a counter-locking element on the housing in the closed position.

The arm may, for example, be provided with a locking recess, which is brought into engagement with a complementary locking protrusion in the interior of the housing at the closed position of the flap. In accordance with another embodiment, the locking element can be implemented as a locking projection and the counter-locking element can be implemented as locking protrusion which projects in the interior of the housing, the locking projection engaging behind said locking protrusion at the closed position of the flap.

The lateral cheeks of the flap have associated therewith complementary lateral housing end walls in the housing. These end walls can have formed therein recesses which are open in the direction of the flap and which accommodate, in the closed position of the flap, mating bodies arranged on the lateral cheek. By means of this arrangement, e.g. the closed position of the flap can be fixed.

The mating bodies can be formed directly on the lateral ends of the flap or also on the lateral cheeks. In order to be able to use the mating bodies also as actuating elements for elastically deflecting the arms, the mating bodies can especially be arranged on the free ends of the arms. The arms can be deflected by applying pressure to the mating bodies in the direction of the flap so that the engagement of the locking element and of the counter-locking element can be released. Reference should here be made to the fact that the flap can also be implemented with only one lateral cheek, with suitable locking means in the area of this lateral cheek and with only one mating body. Two lateral cheeks with suitable locking elements and mating bodies are, however, normally preferred for better handling and fixing of the flap in the closed position.

Mating bodies of sufficient size and of an ergonomically advantageous shape are obtained when the recesses are e.g. semicircular and when the mating body has the shape of a circular segment. The mating bodies can then easily be moved from their outward to their inward position when a user applies pressure thereto with his finger-tips.

In order to be able to realize the locking protrusion in the area of the recess and close to the recess, an edge of the recess can be implemented as a locking protrusion along at least part of its length.

In order to improve the outward appearance of the film dispenser in the closed position of the flap, the flap can be provided with a boundary projection which is located above the mating body and which, at the closed position of the flap, is arranged in the recess such that it is flush with the surface of the front side of the housing. The mating bodies extend up to a point close to the boundary projections, which can be arranged such that they are not only flush with the surface of the front side but also flush with the side faces of the housing. In order to be able to form the arm easily in the lateral cheeks, said arm can be delimited in the lateral cheeks of the flap by two slot-shaped openings which are open towards the boundary projection. The lateral cheek including the arm and respective other components can thus be produced as an integral component.

An axle guide means, which is open towards the recess and which is used for accommodating the support axle projecting from the side face of the flap, can be formed laterally adjacent to the recess on the housing so that the flaps can be pivotably supported in an easy manner and so that said flaps can also be released from the housing, if desired. The axle guide means is, on the one hand, used for pivotably supporting the support axle and, on the other hand, said support axles can be removed from said axle guide means via the opening facing the recess and the flap can be released from the housing in this way.

It is possible that the base element is guided directly along an inner side of the flap and that it abuts there at least partially. In order to prevent the base element and thus the guide means of the separating device from being damaged or from being impeded by the roll of film arranged in the dispensing compartment, a guide channel, which extends along the cutting slot, can be formed on an inner side of the flap facing the housing, the base element being accommodated and/or guided in said guide channel.

In order to save material in the production of the guide channel, the side walls of said guide channel can be provided with longitudinal openings which are spaced apart in the longitudinal direction.

One of said longitudinal openings can be implemented as an insertion opening for the separating knife so that the separating device can easily be mounted in the case of such a guide channel. When the separating knife has been inserted in the insertion opening and when the separating knife has been passed through the cutting slot, it can be secured in position on an outer side of the flap on the respective handle housing.

In order to guide the base element more effectively, the side walls of the guide channel can enclose an acute angle with the inner side of the flap, whereby the side walls will extend towards one another away from the inner side and whereby the guide channel will be given a trapezoidal cross-section.

The base element can have different structural designs, cf. DE 93 21 258 U, which has already been mentioned. The base element can, for example, directly abut on the edges of the cutting slot and it can be guided along these edges. It is also possible to arrange at least one guide means for the base element along the cutting slot on the inner side of the flap. The base element can then be provided with a suitable structural design so that it can be guide along these guide means.

In order to be able to release the separating device from the flap also without demounting the handle housing, the flap can be provided with a pivotable flap which defines an edge of the cutting slot in the closed position thereof. When this pivotable flap is opened, the separating device can be removed.

In order to facilitate the support of the pivotable flap on the flap, said pivotable flap can be pivotably supported on the flap through a film hinge.

In order to reliably fix the pivotable flap at its closed position, the lower side of said pivotable flap can be provided with at least one locking projection which engages a longitudinal opening of the guide channel when the flap occupies the closed position. The locking projection can be manually released from its locking engagement, e.g. when the flap is open.

In order to facilitate the release of the locking projection, said locking projection can be formed on an elastically deflectable locking arm.

In order to permit easy insertion of the separating profile section and of the separating de vice also from the front side of the flap, the flap can be provided with a guide channel which extends in the longitudinal direction thereof and which has arranged therein a strip comprising the cutting slot of the separating profile section, said strip being especially removably arranged in said guide channel. The separating device can be inserted simultaneously with said strip.

Normally, the strip with the separating device is installed in the film dispenser so that a slip of film drawn out of the film dispenser can be cut off. If the strip is, however, removable, it can also be used for the purpose of cutting separately from the film dispenser. For this purpose, the strip can be placed onto a flat support, such as a table or the like. By means of the separating device guided along the strip, the film in question can then also be cut off independently of the film dispenser.

The strip can be installed e.g. from one end of the guide channel, and, in this case, said guide channel can be open on at least one end thereof.

In order to obtain a smooth front side of the flap in cases in which the strip is used, said strip can be adapted to be arranged in the guide channel such that its upper surface is substantially flush with the front side of the flap, the cutting slot extending in said upper surface.

In connection with a strip that is adapted to be used separately, it may, however, turn out to be advantageous when said strip has a substantially square cross-section, with lateral support flanges projecting from the upper surface thereof. When the strip is arranged in the front side of the flap, also these support flanges can be adapted to be arranged such they are flush with the front side of the flap, provided that suitable recesses for said support flanges are formed in said front side. If the strip is, however, used separately from the film dispenser, the support flanges can be used for improved support of a film and for the sub sequent cutting of this film.

In order to be able to use the strip also for guiding the separating device the strip can be substantially hollow and the base element of the separating knife can be guided therein.

It is also possible to dispense with open ends of the guide channel in cases in which the strip is e.g. adapted to be inserted into the guide channel and to be then locked in position therein. Alternatively, the strip can also be secured in position in the guide channel in some other way, such as by means of screws, by means of an adhesive or the like.

According to an advantageous embodiment, the strip can be formed of a plastic profile section which can be produced as an integral component.

A friction-increasing coating can be applied along the cutting slot, at least along one side thereof, so as to reliably prevent the film from slipping along the cutting slot when the separating device is being displaced.

In order to guarantee that the moving strips circulate when the separating device moves along the cutting slot, the moving strip can be formed of a material with increased friction, or the outer surface thereof, which comes into contact with the slip of film, can comprise said material.

The housing can have a rear wall which extends at an oblique angle upwards and forwards so that the films/foils will be more easily accessible to the user of the film dispenser and so that the slip of film can be cut off more easily. This has the effect that, although the rest of the front side of the housing extends vertically, the dispensing compartments and the flaps will be arranged such that they extend at an oblique angle towards the user, when the film dispenser is attached to the wall.

A holder for a roll of paper can be arranged, especially in a pivotable manner, on the lower side of the housing so that the film dispenser according to the present invention can be used for supporting and keeping at hand also a paper roll in addition to a roll of plastic film and a roll of aluminium foil.

In the following advantageous embodiments of the present invention will be explained in detail on the basis of the figures enclosed as drawings, in which:

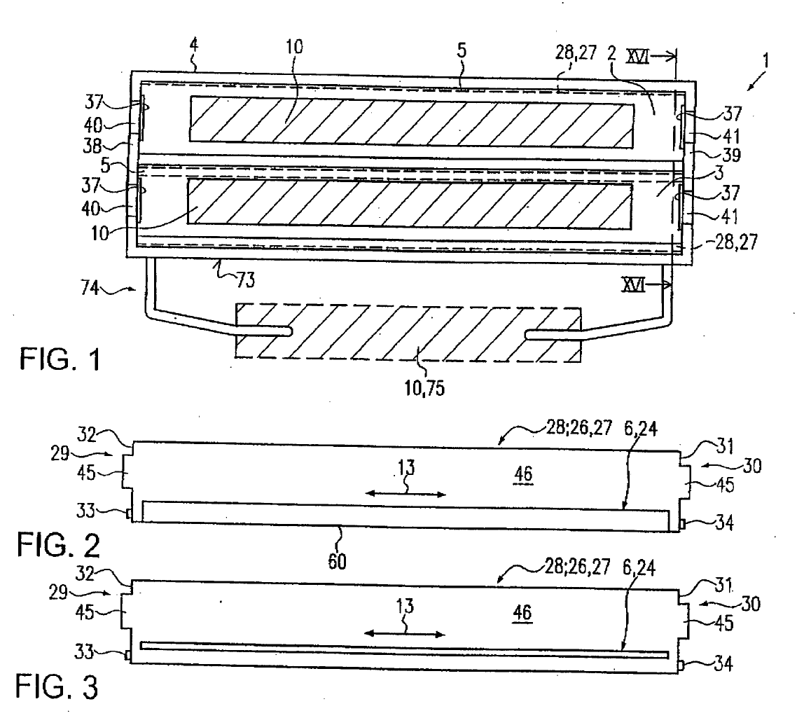

FIG. 1 shows a front view of the film dispenser according to the present invention without any flaps;

FIG. 2 shows a front view of a first flap for the film dispenser according to FIG. 1;

FIG. 3 shows a front view of a second flap for the film dispenser according to FIG. 1 and of an analogous separate separating device;

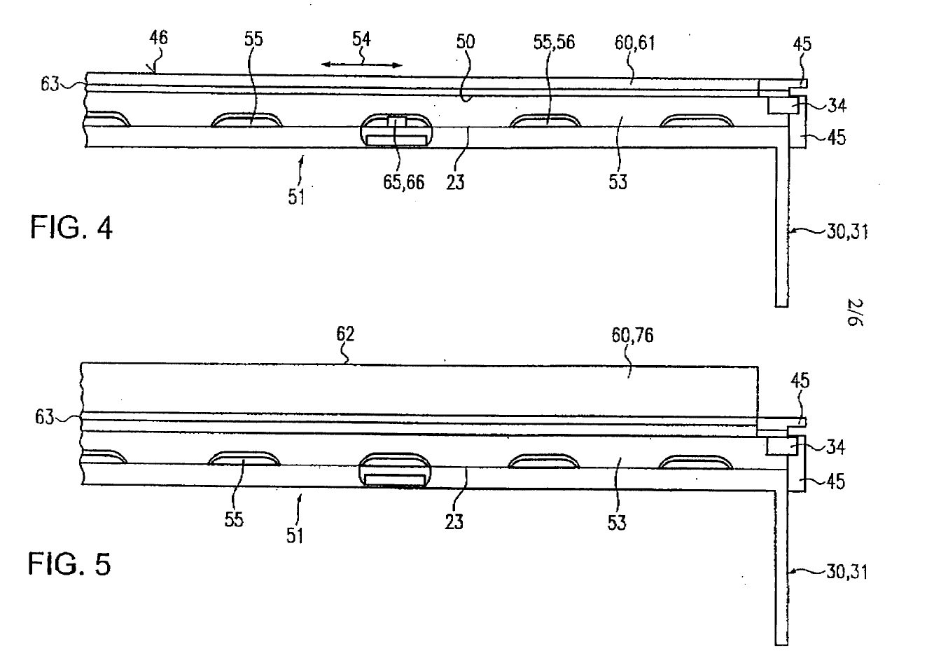

FIG. 4 shows a side view of the flap according to FIG. 2 with a closed pivotable flap;

FIG. 5 shows a side view analogous to FIG. 4 with an open pivotable flap;

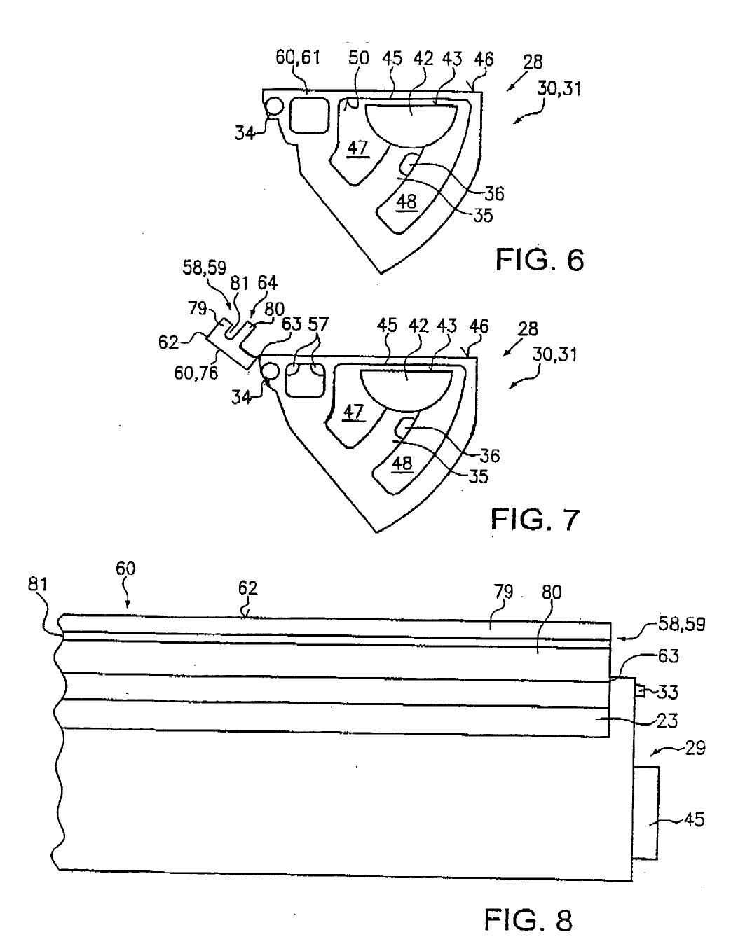

FIG. 6 shows a view of a lateral cheek of a flap with a closed pivotable flap;

FIG. 7 shows a view analogous to FIG. 6 with an open pivotable flap;

FIG. 8 shows a top view of the flap according to FIG. 2 with an open pivotable flap;

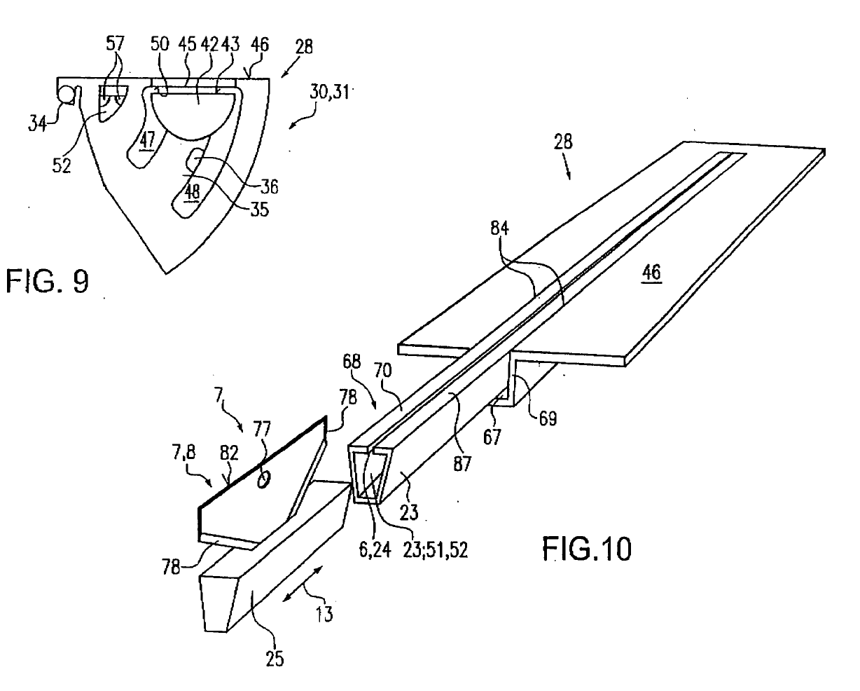

FIG. 9 shows a view of a lateral cheek of the flap according to FIG. 3;

FIG. 10 shows, at an oblique angle from above, a perspective view of a further embodiment of a flap;

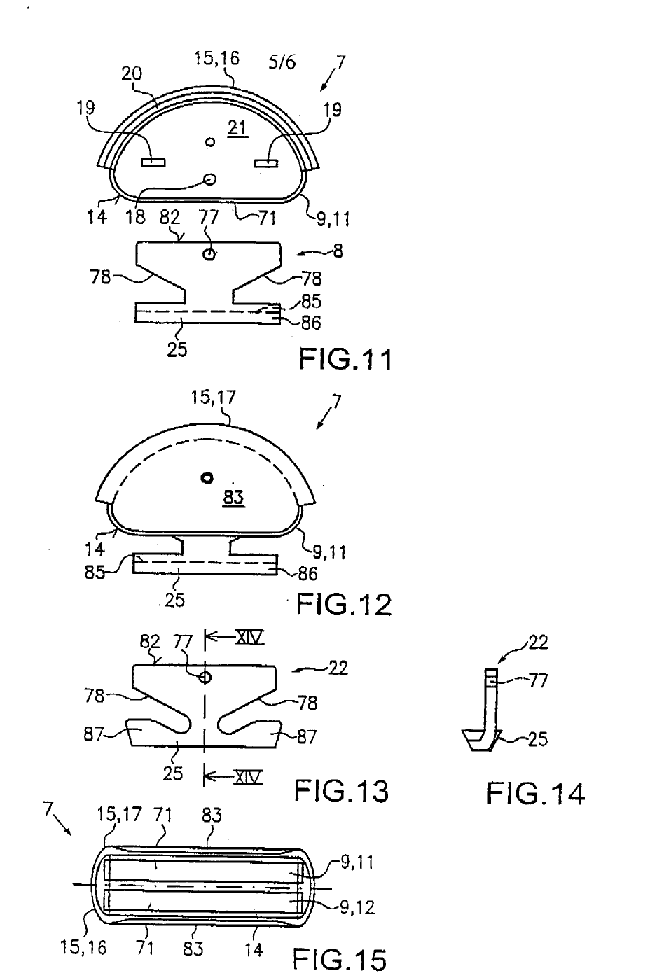

FIG. 11 shows a separating knife with a handle-housing half for use in a separating device according to the present invention:

FIG. 12 shows a side view of a separating device, the separating profile section and the material being not shown to make things easier;

FIG. 13 shows a side view of a further separating knife;

FIG. 14 shows a section along line XIV-XIV according to FIG. 13;

FIG. 15 shows, in a view from below, a separating device according to FIG. 12 without a separating knife, and

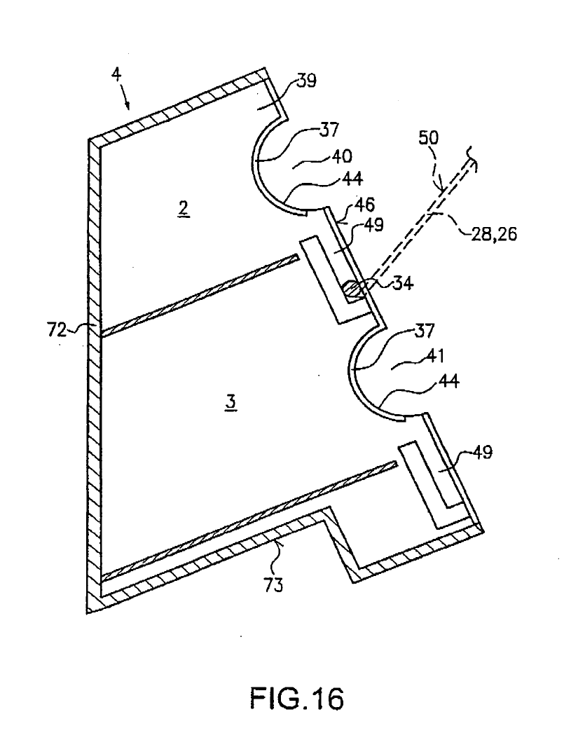

FIG. 16 shows a section along line XVI-XVI of FIG. 1.

FIG. 1 shows a front view of an embodiment of a film dispenser 1 according to the present invention. This film dispenser comprises two dispensing compartments 2, 3 which are arranged one on top of the other. A roll of film or foil 10 is rotatably arranged in each dispensing compartment. One of said rolls of film or foil can be a plastic film and the other one an aluminium foil.

The dispensing compartments 2 are arranged in a housing 4 of the film dispenser 1 and are adapted to be closed by flaps 28, two flaps 28 being shown at their closed positions 27 by a broken line in FIG. 1. Between the flaps 28 and the housing 4 and between the flaps 28 themselves, dispensing openings 5 are arranged, which are used for withdrawing the films from the rolls of film 10.

The flaps 28 are arranged on housing walls 38, 39 of the housing 4 such that they are pivotable between their closed position 27 and their open position 26, cf. also FIG. 16. The housing walls 38, 39 are provided with recesses 40, 41 having an edge 44 (FIG. 16). The recesses 40, 41 are semicircular.

A holder 74 is pivotably arranged on the lower side 73 of the housing 4, a roll of paper 75 being rotatably supported as an additional roll of film/foil 10 between the ends of said holder which are directed towards one another.

FIG. 2 shows a top view of a flap 28, said flap being associated with the lower dispensing compartment 3 in FIG. 1. The flap 28 has projecting support axles 33, 34 on the lateral ends 29, 30 thereof. By means of these support axles, the flap 28 is supported such that it is pivotable between the closed position and the open position in the housing 4. On the lateral ends 29, 30 of the flap 28, lateral cheeks 31, 32 project in the direction of the dispensing compartment 3. Boundary projections 45 project beyond these lateral cheeks 31, 32 in the direction of displacement 13 of a separating device 7 which will be described hereinbelow; when the flap 28 occupies its closed position 27, these boundary projections 45 engage the recesses 40, 41 and are arranged such that they are flush with the surface of the front side 46 of the housing 4, cf. also FIG. 16.

The flap 28 has formed therein a separating profile section 6 with a cutting slot 24 along which a separating device 7, which is not shown, is movable in the direction of displacement 13. The flap 28 according to FIG. 2 is additionally provided with a pivotable flap 60 which delimits the cutting slot 24 on one side thereof. The pivotable flap 60 will be de scribed in more detail in connection with the subsequent figures.

FIG. 3 shows a top view of a further flap 28, which is adapted to be associated with the dispensing compartment 2 according to FIG. 1. This flap 28 has the separating profile section 6 and the cutting slot 24 integrated therein. Analogously to the flap 28 according to FIG. 2, the flap according to FIG. 3 is provided with corresponding lateral ends 29, 30 with lateral cheeks 31, 32 and support axles 33, 34.

FIGS. 4 and 5 show a lateral view of the flap 28 according to FIG. 2. In these figures and also in all the other figures identical parts are designated by identical reference numerals and for describing, corresponding parts reference will also be made to the other figures.

In FIG. 4 the pivotable flap 60 is arranged at its closed position 61, cf. also FIG. 2. Only part of the flap 28 and, in particular, only one of its lateral ends 30 with lateral cheek 31 is shown. On the inner side 50 facing the dispensing compartment, the flap 28 is provided with a guide means 23 in which the separating device 7 is supported such that it is movable in the longitudinal direction 54, cf. FIG. 11 to 15. The guide means 23 is essentially defined by a guide channel 51, 62 with side walls 53. The side walls 53 have provided therein longitudinal openings 55 which are spaced apart in the longitudinal direction 54. One of these longitudinal openings 55 can be designed as an insertion opening 56 having an increased length in the longitudinal direction 54 so that the separating device 7 can be inserted through this insertion opening 56 and mounted in the guide channel 61, 62.

On the lateral end 30, the plate-shaped lateral cheek 31 is arranged. This lateral cheek 31 extends essentially at right angles to the front side 46 of the flap 28. A mating body 42, which engages a complementary recess 40, 41 of the housing 4 when the flap 28 occupies it closed position 27, is arranged on the upper end of the lateral cheek 31.

The boundary projection 45 projects laterally beyond the flap 28 above the mating body 42. Furthermore, the support axle 34, which projects beyond the lateral end 30, is arranged directly adjacent to the guide channel 51, 52.

In FIG. 5 the flap 28 is shown in a condition in which the pivotable flap 60 occupies its open position 76. The pivotable flap 60 is connected to the flap 28 via a film hinge 63. An edge 62 of the pivotable flap 60 defines an edge of the cutting slot 24, cf. also FIG. 2.

In FIGS. 6 and 7 corresponding side views of the ends 30 of the flaps 28 according to FIGS. 4 and 5 are shown. In FIG. 6 the pivotable flap 60 is arranged at its closed position and in FIG. 7 it is arranged at its open position 76.

The lateral end 30 is defined by the lateral cheek 31. This lateral cheek 31 has an elastically deflectable arm 35, which extends at an oblique angle upwards and which is delimited on both sides thereof by slot-shaped openings 47, 48 that are open towards the boundary projection 45. The mating body 42 is arranged at the free end 43 of the arm 35. This mating body 42 has approximately the shape of a circular segment, the periphery of said circular segment facing the arm 35. The arm 35 has arranged thereon a locking projection, which is located below the mating body 42 and which acts as a locking element 36. When the flap 28 occupies its closed position 27, this locking projection engages behind the edge 44 of the recesses 40, 41, said edge 44 being implemented as a counter-locking element 37 or locking protrusion.

When the pivotable flap 60 occupies its open position 76, a guide means can be seen on the lower side 64 thereof. This guide means is defined by two guide webs 79, 80 and a guide groove 81 arranged therebetween. The guide web 79 is implemented such that its height is lower than that of the guide web 80. A base element 26 of the separating device 7, cf. especially FIGS. 11 and 12, is adapted to be moved along the guide webs and also along the guide groove 81.

The side walls 53 of the guide channel 61, 52, cf. also FIGS. 4 and 5, enclose an angle 57 with the inner side 50 of the flap 28. In the case of the flap according to FIG. 3, said angle 57 may be an acute angle so that the respective side walls 53 extend towards one another away from the inner side 50.

In FIG. 8, the pivotable flap 60 has been opened completely and the guide means 23, along which the separating device 7 is guided, is visible. Furthermore, it is again possible to see the guide webs 79, 80 and the intermediate guide groove 81, which serve to displaceably support a respective base element 25 of the separating device 7.

FIG. 9 shows a view of a lateral cheek 31 on the lateral end 30 of the flap 28 according to FIG. 3. The structural design of the lateral cheek, which comprises an arm 35, a mating body 42 and a locking projection 36 as well as slot-shaped openings 47, 48, is essentially analogous to that of the lateral cheek according to FIGS. 6 and 7. A difference from the hitherto shown lateral cheek is that the flap 28 does not comprise a pivotable flap 60, but, cf. also FIG. 3, that the cutting slot 24 is arranged directly in the front side 46 of the flap 28. Furthermore, an acute angle 57 is formed between the side walls 53 of the guide channel 51, 52 and an inner side 50 of the flap 28.

FIG. 10 shows, at an oblique angle from above, a perspective view of a further embodiment of a flap 28. In this embodiment, a guide channel 67, which is adapted to have inserted therein a strip 68, is formed in said flap 28. The strip 68 can be inserted from the front side 46 of the flap 28 into the guide channel 67 where it can be fixed in position through an edge locking means 84. The strip 68 is formed of a plastic profile section and includes in the upper surface 70 thereof the cutting slot 24 of the separating profile section 6. For locking the strip 68 in the guide channel 67, said strip can be compressed in the direction of the cutting slot 24 and, due to its inherent elasticity, said strip 68 will lockingly engage the edge locking means 84 after having been inserted in the guide channel 67. The guide channel 67 and the strip 68 are implemented such that, when said strip 68 has been inserted in the guide channel, its upper surface 70 will be arranged such that it is flush with the front side 46 of the flap 28.

In an embodiment of the strip 68 which is not shown, said strip can be used independently of the film dispenser 1. For this purpose, the strip is removed from the guide channel 67 and placed onto a substantially flat support, such as a table or the like. A slip of film length is placed onto the upper surface 70 of said strip 68, which may be provided with laterally projecting support flanges, and cut off by means of the separating device 7. In this way, the strip 68 can be used for cutting respective films/foils independently of the film/foil dispenser. Depending of the type of film/foil, the separating device can formed with a suitable cutting knife.

The strip 68 is implemented such that its interior is hollow and, consequently, it serves directly as a guide means 23 or guide channel 51, 52 for a base element 25 of a separating device 7; the part of said separating device 7 shown in FIG. 10 is essentially only a separating knife 8 and the base element 25 arranged on the lower end of said knife.

The base element 25 has a cross-section which is complementary to the cross-section of the strip 68. The separating knife 8 is secured to the base element 25 and has cutting edges 78 on both sides and above the base element 25, said cutting edges 78 being displaceable through the cutting slot 24 along the direction of displacement 13. An attachment hole 77 is arranged centrally between the cutting edges 68 and adjacent to a contacting edge 82 of the separating knife 8.

FIG. 11 shows a further embodiment of the separating device 7, which is adapted to be used in the film dispenser according to the present invention. The separating device 7 is provided with a two-part handle housing 15 comprising handle-housing halves 16 and 17, cf. also FIG. 12. The handle-housing half 16 according to FIG. 11 comprises a pin-shaped fastening element 18 on an inner side facing the separating knife 8 and, above said fastening element, two spaced-apart stop elements 19. The separating knife 8 is adapted to be attached to said fastening element 18 with its attachment hole 77, and the contacting edge 82 abuts on the stop elements 19 from below. The handle-housing half 16 may also have formed therein a step-shaped single stop element 19 instead of two spaced-part stop elements 19.

The handle-housing half 16 or 17 is provided with an approximately kidney-shaped guide member 21 around which a moving strip 11 is guided as a press element 9. Another moving strip 12 is movably supported in the other handle-housing half 17 in a corresponding manner. In the upper area of the guide member 21, said guide member 21 is surrounded by a slot-shaped guide means 20 which has the moving strip 11 or 12 inserted therein. The moving strip is placed around the guide member 21 with a certain amount of play and it is adapted to be pressed onto the areas adjacent the cutting slot 24 especially by the lower surface of the guide member 21, said lower surface acting as a parallel guide means 14.

The separating knife 8 according to FIG. 11 is made of metal and serves to cut a plastic film; analogously to the embodiment according to FIG. 10, it is provided with two lateral cutting edges 78. The lower end of the separating knife 8 is secured to the base element 25. This base element has a step-shaped structural design, one step surface abutting on the free end of the guide web 79 and a step rear wall 86 engaging the guide groove 81, cf. in this respect especially FIG. 7.

FIG. 12 shows the separating device 7 according to FIG. 11 in the assembled condition, the additional handle-housing half 17 being connected to the handle-housing half 16, which is shown in FIG. 11, e.g. in that the handle-housing halves are screwed together. On the outer sides of the handle-housing halves 16, 17 a recessed grip 83 is formed so that the separating device 7 can be handled more easily.

A respective moving strip 11, 12 is movably guided in either handle-housing half 16, 17, cf. in this respect FIG. 11.

In FIGS. 13 and 14 another separating knife 22 is shown as a further embodiment of a separating device 7. This separating knife 22 is made of plastic material and serves to cut an aluminium foil. Analogously to the former separating knives, it is provided with two lateral cutting edges 78. In this case, the separating knife 22 is formed integrally with a base element 25 consisting of plastic material. The base element 25 has guide shoes on the free ends thereof, said guide shoes serving to guide said base element 25 along the guide channel 51, 52, cf. e.g. FIG. 9.

FIG. 14 shows a section along line XIV-XIV of FIG. 13 through the separating knife 22. The trapezoidal shape of the lateral guide shoes 87 is here especially visible, the shape of said guide shoes being adapted to the cross-section of the guide channel 52, cf. FIG. 9.

FIG. 15 shows the separating device 7 according to the preceding figures, without the respective separating knife 8, 22. In a view from below. The two handle-housing halves 16, 17, cf. also FIG. 12, are screwed together and have approximately symmetrical structural designs. A moving strip 11, 12 is movably supported in each handle-housing half 16, 17. The outer surfaces of the handle-housing halves 16, 17 are provided with recessed grips 83.

The moving strips 11, 12 can be coated with a friction-increasing material on the respective outer side facing the flap 28 in question, or they may be produced from this material completely. A respective friction-increasing material 87, cf. FIG. 10, may also be applied to the upper side 70 of the strip 68 along the cutting slot 24.

In a further embodiment of the present invention, the separating device 7 is composed of a smaller number of individual parts. The handle housing 16, 17 is here implemented as an integral and essentially U-shaped component. The handle housing is adapted to have inserted therein an inner member, said inner member being especially locked in position in said handle housing. The moving strips 11, 12 are movably guided around said inner member, cf. in this respect also FIG. 15. The separating knife 22 projects beyond the lower surface of said inner member at a point located centrally between the moving strips 11, 12. Due to the locking engagement between the handle housing and said inner member, the handle housing can be replaced easily, and inner members and handle housings are constructed such that inner members provided with different separating knives can be connected to a respective handle housing having the same type of structural design.

The inner member is preferably made of plastic material. If also the separating knife is made of plastic material for cutting an aluminium foil, the separating knife and the inner member can be produced as an integral component in one production process.

If the separating knife is made of metal for cutting a plastic film, the separating knife is connected, especially releasably connected, to the inner member, or the inner member is attached to the metal separating knife by injection moulding.

The locking engagement between the handle housing and the inner member can be established by means of respective locking elements and counter-locking elements provided on the two individual components. It goes without saying that a different type of releasable fastening between the separating knife and the handle housing, such as screwing together, connection by means of an adhesive, etc., is possible as well.

In FIG. 16 a section along line XVI-XVI of FIG. 1 is shown.

In FIG. 16 it can especially be seen that a rear wall 72 of the housing 4 extends, relative to the front side 46, at an oblique angle from the bottom to the top. When the rear wall 72 of the film dispenser according to the present invention is secured to a wall or the like, the dispensing compartments 2, 3 extend at an oblique angle towards the user. The dispensing compartments 2, 3 are subdivided by at least one intermediate wall; e.g. a respective roll of film 10, cf. FIG. 1 can simply be placed on top of said intermediate wall, or it can be rotatably supported on the ends thereof in a manner known per se.

The recesses 40, 41 are semicircular and have along the edge 44 thereof a locking protrusion 37, which extends at least along part of the circumference of said recesses and which is used as a counter-locking element for lockingly engaging the locking projection 36 on the arm 35 of the lateral cheeks 31, 32, cf. also FIGS. 6, 7 and 9.

The locking protrusion 37 is interrupted at one point. At this point, an axle guide means 49 for the support axles 33, 34 is formed on the inner side of the housing end wall 39. The axle guide means 49 is open towards the recesses 40, 41 so that, on the one hand, the flap 28 is supported in said axle guide means 48, 49 such that it is pivotable between the closed position 27 and the open position 26, and so that, on the other hand, the support axles 33., 34 of said flap 28 can be removed from said axle guide means 49 via the recesses 40. The flaps 28 can be detached fully from the rest of the housing 4 in this way.

1. A separating device, in particular for use in a film dispenser, including a separating profile section, said separating device, which comprises at least one separating knife and a press element, being supported such that it is movable along said separating profile section relative to a material that is adapted to be cut, in particular a material in the form of webs or sheets, wherein the press element is implemented as a moving strip which is supported such that it is adapted to circulate at least in said separating device and which causes the material adjacent to the separating knife to remain tensed at least in a linear manner along the direction of displacement of said knife, wherein the separating device comprises a handle housing provided with a guide member and that the moving strip is placed around said guide member with a certain amount of play.

2. A separating device according to claim 1, wherein the material has the form of a slip of film.

3. A separating device according to claim 1, wherein at least one moving strip is arranged on either side of the separating knife.

4. A separating device according to claim 1, wherein the moving strip is rotatably supported.

5. A separating device according to claim 1, wherein the moving strip is guided essentially parallel to the separating profile section in the direction of displacement of the separating knife.

6. A separating device according to claim 1, wherein a parallel guide means of the separating device, which is used for guiding the moving strip, extends beyond the separating knife on both sides in the direction of displacement.

7. A separating device according to claim 1, wherein the separating device comprises a handle housing, especially a bipartite handle housing, in which the separating knife is held and in which the moving strip is guided.

8. A separating device according to claim 1, wherein the separating device comprises a handle housing which is adapted to be lockingly attached to an inner member, the moving strips being placed around said inner member and the separating knife projecting, between the moving strips, beyond a lower surface of said inner member.

9. A separating device according to claim 1, wherein at least one handle-housing half is provided with a fastening element for the separating knife, and that one handle-housing half is provided with a stop element for the separating knife.

10. A separating device according to claim 1, wherein the fastening element and/or the stop element are implemented as peg- or pin-shaped elements.

11. A separating device according to claim 1, wherein the handle-housing half is provided with a slot-shaped guide means for the moving strip.

12. A separating device according to claim 1, wherein one moving strip is guided in each handle-housing half.

13. A separating device according to claim 1, wherein the separating knife is held between the handle-housing halves.

14. A separating device according to claim 1, wherein the separating knife and the inner member are formed as an integral component.

15. A separating device according to claim 1, wherein the moving strip is guided with a certain amount of play around an approximately kidney-shaped guide member in the handle-housing half.

16. A separating device according to claim 1, wherein the separating knife used for cutting a plastic film is made of metal.

17. A separating device according to claim 1, wherein the separating knife is injection molded into said inner member.

18. A separating device according to claim 1, wherein the separating knife used for cutting an aluminum foil is made of plastic material.

19. A separating device according to claim 17, wherein the separating knife is formed integrally with said inner member from plastic material.

20. A separating device according to claim 1, wherein the separating knife is provided with a base element which is guided in a suitable guide means along a cutting slot of the separating profile section.

21. A film dispenser provided with a separating device, said film dispenser comprising a housing provided with at least one dispensing compartment and the separating profile section being associated with a dispensing opening of a dispensing compartment, wherein the separating profile section is formed in a flap which is associated with the dispensing compartment and which is supported such that it is pivotable between an open position and a closed position, said flap being releasably locked with said housing especially in the closed position.

22. A film dispenser according to claim 21, wherein especially by means of support axles projecting from the lateral ends of the flap, the flap is at the lateral ends thereof supported in the housing such that it is adapted to be pivoted and/or locked in said housing.

23. A film dispenser according to claim 21, wherein lateral cheeks projecting from lateral ends of the flap in the direction of the respective dispensing compartment have an elastically deflectable arm on which a locking element is arranged, said locking element being in engagement with a counter-locking element on the housing in the closed position.

24. A film dispenser according to claim 21, wherein recesses are formed in lateral housing end walls, said recesses being open in the direction of the flap and accommodating mating bodies arranged on the lateral cheek, especially on the free end of the arm, in the closed position of the flap.

25. A film dispenser according to claim 21, wherein the recess is essentially semicircular and that the cross-section of the mating body has essentially the shape of a circular segment.

26. A film dispenser according to claim 21, wherein an edge of the recess is implemented as a locking protrusion along at least part of its length.

27. A film dispenser according to claim 21, wherein the flap is provided with a boundary projection, which is located above the mating body and which, at the closed position of the flap, is arranged in the recess such that it is flush with the surface of the front side of the housing, especially the arm in the lateral cheek of the flap being delimited by two slot-shaped openings which are open towards said boundary projection.

28. A film dispenser according to claim 21, wherein an axle guide means for accommodating the support axle projecting from the side face of the flap is formed laterally adjacent to the recess on the housing, said axle guide means being open towards said recess.

29. A film dispenser according to claim 21, wherein on an inner side of the flap facing the housing, a guide channel is formed, which extends along the cutting slot and in which the base element is accommodated and/or guided.

30. A film dispenser according to claim 21, wherein the side walls of said guide channel are provided with longitudinal openings which are spaced apart in the longitudinal direction, especially one of said longitudinal openings being implemented as an insertion opening for the separating knife.

31. A film dispenser according to claim 21, wherein the side walls of said guide channel enclose an acute angle with the inner side of the flap.

32. A film dispenser according to claim 21, wherein at least one guide means for the base element is arranged along the cutting slot on the inner side of the flap.

33. A film dispenser according to claim 21, wherein the flap is provided with a pivotable flap which is pivotably supported thereon through a film hinge and which defines an edge of the cutting slot in the closed position thereof.

34. A film dispenser according to claim 21, wherein the pivotable flap has, on the lower side thereof, at least one locking projection formed especially on an elastically deflectable locking arm and engaging a longitudinal opening of the guide channel when the flap occupies the closed position.

35. A film dispenser according to claim 21, wherein the flap is provided with a guide channel which extends in the longitudinal direction thereof and which has arranged therein a strip comprising the cutting slot of the separating profile section, said strip being especially removably arranged in said guide channel.

36. A film dispenser according to claim 21, wherein the strip provided with the separating profile section and used for cutting the film/foil is adapted to be handled independently of the film dispenser.

37. A film dispenser according to claim 21, wherein the guide channel is open on at least one end thereof.

38. A film dispenser according to claim 21, wherein the strip is adapted to be arranged in the guide channel in such a way that its upper surface is substantially flush with the front side of the flap, the cutting slot extending in said upper surface.

39. A film dispenser according to claim 21, wherein the strip has a substantially square cross-section with support flanges projecting outwardly from the upper surface thereof.

40. A film dispenser according to claim 21, wherein the strip is substantially hollow and that the base element of the separating knife is guided in said strip.

41. A film dispenser according to claim 21, wherein the strip is adapted to be secured in position, especially locked in position in the guide channel.

42. A film dispenser according to claim 21, wherein a friction-increasing coating is applied along the cutting slot, at least along one side thereof.

43. A separating device according to claim 21, wherein the moving strip is formed of a material with increased friction, or that the outer surface thereof, which comes into contact with the slip of film, comprises said material.

44. A film dispenser according to claim 21, wherein the housing has a rear wall which extends at an oblique angle upwards and forwards.
